(19) United States
(12) Patent Application Publication
(10) Pub. No.: US 2004/0099991 A1
(43) Pub. Date: May 27, 2004

(54) Apparatus and method for balanced embossing

(76) Inventors: Karl Shaw, Victor, NY (US); Thomas Greenberg, Bergen, NY (US); James Garcia, Honeoye Falls, NY (US)

Correspondence Address: William B. Ritchie, 43 Jackson Street, Concord, NH, 03301, US

(21) Appl. No.: 10/305,428

(22) Filed: Nov. 26, 2002

(51) Int. Cl. B29C 43/46

(52) U.S. Cl. 264/284; 425/294; 425/363; 264/293

(57) ABSTRACT

A method and an apparatus for sheet embossing are disclosed that imparts the same strain on each side of the sheet independent of pattern pick-up. By balancing the plastic deformation at each surface the stresses in the formed material are well controlled and, in fact, greatly improve the sheet flatness, material internal stress, surface corrosion and other properties associated with this balanced process. Controlled sheet shape is important to the industrial handling of material on conveyers, spoolers, stackers and other transport devices. Current industrial practice often mandates the use of sheet levelers that reform the surface through a series of rollers that plastically force the material flat, however, not at controlled stress. With the invention, expensive levelers are often not necessary and, as such, the overall process becomes more efficient.

### FIELD OF THE INVENTION

The present invention relates to the field of embossing and, in particular, to an apparatus and method for embossing sheet material with a controlled sheet shape.

### BACKGROUND OF THE INVENTION

This invention is particularly applied to the rotary embossing of sheet stock as this has proven to be the most efficient way to apply a texture to material surfaces. This invention describes a condition for the pattern on the rollers that balance the embossing. Prior to this invention there has been no efficient way to insure that the embossing pattern is balanced, or that this even was a desired condition.

Many industrial materials are embossed to improve appearance or for other functional reasons such as slip resistance, strength, reflectivity or heat transfer. Most plastic and metal components require some form of surface finishing to hide defects and fingerprints.

Typical applications include the embossing of metal and plastic sheet for buildings, appliances, automotive parts, consumer products, heat exchanges and many other industrial uses. After embossing other secondary processes are utilized to fabricate parts including leveling, slitting, cutting, forming, and joining. The handling of the sheet becomes more difficult if the material does not lie flat, or if the material has significant internal stress that causes warpage at a later stage.

Rotary embossing techniques are used for sheet stock as this has proven to be the most efficient way to apply a texture to sheet material surfaces. As the sheet is relatively thin but wide and long, the surface stresses in the sheet control sheet properties, particularly the flatness and corrosion resistance. The sheet is fed between two embossing rollers that are mated as a male/female combination under significant force to impart a pattern into the sheet material.

Typical patterns represent wood or leather but many other decorative effects are utilized dependent on the design of the product. The rollers are geared to each other to insure that the pattern is consistent. The pattern is engraved onto the rolls so no seam is evident in the embossed material and as such the pattern must be continuous. Typical applications include the embossing of metal and plastic sheet for buildings, appliances, automotive parts, consumer products, heat exchanges and many other industrial uses.

During rotary embossing, material of a certain thickness or gauge is fed between two rollers with a fixed nip or gap. To emboss a pattern on the material, the gap must be less that the gauge. Patterns are engraved on the embossing rolls. One roller is configured as a “male”; the other roller is configured as an exact “female” counterpart so that the two rollers can be mated together.

By adjusting the gap to the material gauge one may control the pattern pickup. For example, if a metal sheet that is 0.020 inches thick is placed between a set of embossing rollers that are gaped to 0.015 inches, nominally 0.0025 inches of pattern are embossed into the metal. As the gap and material change, so does the pattern and forces required for embossing.

Embossing conditions must be controlled to maintain sheet flatness. Friction must be well controlled on each surface and the overall nip and rolls are properly crowned, adjusted and compensated for deflection. A stiff machine is necessary to minimize deflections.

After embossing other secondary processes are utilized to fabricate parts including leveling, slitting, cutting, forming, and joining. The handling of the sheet becomes more difficult if the material does not lay flat, or if warpage occurs. To solve this problem, after the sheet has been embossed, it is then fed through a material leveler to flatten the sheet to its pre-embossed conditions. This extra step increases the cost of the embossing process. Further, the cost of the material leveling machines can often exceed the cost of the embossing machine itself.

A method and apparatus that eliminates the need for a material level machine,to improve efficiency and quality of the sheet embossing process is not found in the prior art.

### SUMMARY OF THE INVENTION

In accordance with one aspect of the present invention, matched rotary embossing rollers for use on a material sheet wherein the mated embossing rollers have equal surfaces areas such that the intersection of sheet stock surface with embossing roller surface is the same on the front and back of the sheet stock at every level in the pattern which ensures that stresses in the sheet stock are balanced.

The balanced embossing process disclosed represents the digital scanning of a surface to be formed and the corresponding mathematical transformation of this data to insure that the plastic strain during material deformation is the same on both sides of the sheet. A simplified way of describing this transformation is to insure that the intersection of the sheet surface with the embossing tool surface is the same on the front and back at every level in the pattern. This boundary condition guarantees that the forming conditions and resulting plastic strains are the same on the front and back of the sheet, and as such the embossing tool imparts similar forces to the front and back simultaneously.

The method is best illustrated by the application of registered, male/female embossing of metals that often undergo significant sheet shape changes after embossing, although this method applies to other material forming processes. Typically metal sheet is fed between two embossing rollers that are mated as a male/female combination under significant force to impart a pattern into the metal. Under the stated boundary condition that the land on the male and female roller is the same at every level of pattern pickup the metal is formed with an even strain imparted to both sides of the sheet. Typically the pattern is designed to place both sides of the sheet under equal levels of compression and the balanced internal stresses allow for the formation of complicated surfaces that retain or can even improve sheet shape properties. Also disclosed is a process to impart controlled radii of curvature on the embossing figures in the pattern to allow for; 1) efficient forming by avoiding high strain levels that can impart cold work in materials which raise sheet yield stress 2) surfaces that preserve release characteristics and 3) surfaces that are coated prior to embossing that can't crack during the embossing process imparting significantly improved corrosion resistance.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is an illustration of prior art matched male/female embossing rollers depicted in both grayscale plots and in a rendered format.

FIG. 2 is an illustration of the rollers in FIG. 1 showing the level of pattern pick-up at representative levels as measured inward from the outermost diameter of the roller.

FIG. 3 is a graph of embossing rollers in FIG. 1 showing the land area (percentage of surface intersection) as function of pattern pick-up from the top most surface of the roller pattern.

FIG. 4 is an illustration of matched male/female embossing rollers depicted in both grayscale plots and in a rendered format in accordance with the invention.

FIG. 5 is an illustration of the rollers in FIG. 4 showing the level of pattern pick-up at representative levels as measured inward from the outermost diameter of the roller.

FIG. 6 is a graph of embossing rollers in FIG. 4 showing the land area (percentage of surface intersection) as function of pattern pick-up from the top most surface of the roller pattern.

FIG. 7A is an illustration of a prior art Seville pattern as typically embossed on refrigerator doors depicted in a grayscale plot as well as a graph showing the land area as a function of pattern pick-up.

FIG. 7A is an illustration of a Seville pattern that is balanced in accordance with the invention as well as a graph showing how this pattern is balanced.

FIG. 8A is an illustration of a prior art wood grain pattern.

FIG. 8B is an illustration of a balanced wood grain pattern.

FIG. 9A is an illustration of prior art embossing pins with straight walls.

FIG. 9B is an illustration of embossing pins with controlled shape and gradual radius of curvature.

FIG. 10 is a table showing a comparison of prior art and the invention with regard to pressure necessary to achieve pattern pickup for the same material thickness and pattern pickup depth.

### DETAILED DESCRIPTION OF THE INVENTION

The subsequent step of passing the embossed sheet through a leveling machine to force the material flat once again upon being embossed is unnecessary under most circumstances as a consequence of the inventor's discovery. The inventors have discovered that the warpage and uneveness of embossed sheet stock is the result of uneven plastic strain placed on both sides of the material during embossing process.

Therefore, by providing matched male/female embossing rollers that impart the same strain on each side of the sheet independent of pattern pick-up, this balances the plastic deformation at the top and bottom surfaces of the sheet and thus greatly improves the flatness, material internal stress as well as corrosion resistance.

The fundamental idea behind this invention is quite simple. If the pattern land at EVERY pickup depth is the same on both the top and bottom rollers, THEN the induced surface strain must be the same on both the top and bottom embossed sheet. Of course other conditions must be controlled to maintain sheet flatness and uniform stress; namely friction must be well controlled on each surface and the overall nip and rolls are properly crowned, adjusted and compensated for deflection. A stiff machine is necessary to minimize deflections. The frictional and stiffness conditions are commonly met using standard industrial practice; however the art of balancing the pattern to induce the same strain on each side of the sheet in a controlled, non random or accidental fashion is new in the art.

Given that the intersection of the top and bottom rollers at every level of pattern pickup must be the same, it is required that the surface must have this property in digital form. Clearly, the process of forcing the pattern into every representative depth level is a nominal start to this process, and it may be sufficient to balance the pattern. What is required is that both the original image and its inverse be present in the surface or that other transforms are applied to make the pattern symmetric in depth about its average, or other integrating function or transformation to mandate the condition that the land area of the top and bottom roller be maintained equivalent at every pattern pickup depth. Using modern computation, the necessary calculations to add both the surface and its inverse are well known in the art; however, the inverse of the pattern must be shifted prior to addition or else the pattern would be cancelled. This changes the scale of the pattern by nominally a factor of two. Subsequent rescaling to the original size then recreates the pattern that is nominally the same as the original; however, it is now balanced and offers improved embossing properties.

A matched set of rollers that accomplishes this task is provided as follows. A mathematical transformation of the embossed surface that is to be balance is calculated so that the intersection of this surface at every level equals its inverse such that the land area of the top and bottom embossing surfaces of the embossing rollers that are applied to the material sheet is the same on the top and bottom roller, and thus the same on the top and bottom of the sheet that is embossed. In this manner, the strain imparted to the material is sufficiently similar on each side of the sheet.

First the surface that is to be embossed is digitized accurately in three dimensions, x, y, and z, with z representing the depth of the embossed surface dimension.

Then this digitized data is transformed so that there are representative features at every depth, z. At this point, several alternative methods of achieving a balanced surface are possible.

First, the depth distribution of the transformed digitized data can be mirrored around the average depth of the top roller pattern to provide the bottom roller pattern. Another possibility is to take the inverse of the pattern of the digitized data that will provide the top roller and add it back to the original data at a slightly different angle to provide the bottom roller pattern. Still another option is to balance the pattern using the digitized data through a different transform function such that the result produces a pattern that exhibits the essence of a balanced pattern in accordance with definition provide herein. Still another possibility is either one, two or three of the above referenced steps either alone in various combinations with one another.

Once the balanced pattern is obtained, the pattern is repeated in both the x and y directions so as to avoid any seem in the embossed product.

Then the pattern is scaled to nominally represent the feature size of the original surface. Finally, the top and bottom patterns are accurately engraved onto a matched roller set so that the balanced pattern can be embossed on a flat sheet. Preferably, this is accomplished via a laser engraving apparatus, well known in the art, to ensure the exact matching of the surface required on the respective rollers to provide the balanced embossing condition.

While the top and bottom rollers may visually appear substantially identical, it must be recognized that top and bottom are still matched mateable pairs such that highs of one roller will have correspondingly lows on the other roller and vice versa.

The other possibility which can also yield a balanced surface is when the top and bottoms may not necessarily look identical to one another, however, the surface land area that is contact with the work piece at all depths for each rollers are equal to one another.

Also disclosed as a part of this process is the use of controlled radii of curvature on the embossing figures in the pattern to allow for; 1) efficient forming by avoiding high strain levels that can impart cold work in materials which raise sheet yield stress 2) surfaces that preserve release characteristics and 3) surfaces that are coated prior to embossing that can't crack during the embossing process imparting significantly improved corrosion resistance.

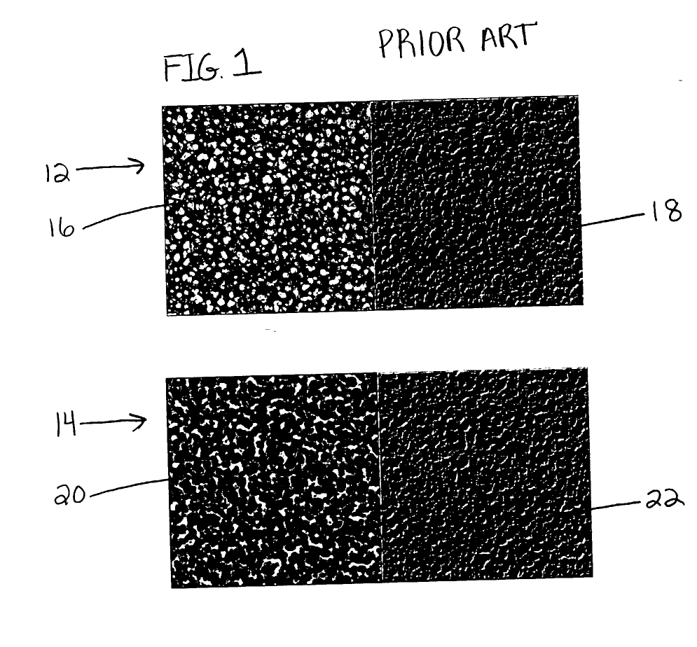

Now referring to FIG. 1, a surface that embodies present practice and is representative of the prior art is depicted. Matched top roller 12 and bottom roller 14 is illustrated in both grayscale plots 16 and 20, respectively as well as shown in a rendered format 18 and 22, also respectively. These are typical surfaces of standard male/female embossing rollers as represented by grayscale plots where the level of grayness represents depth (0 to 255 corresponding linearly to 0 to 0.02 in.) and when rendered, where it is transformed to x. y, z and visually computer.

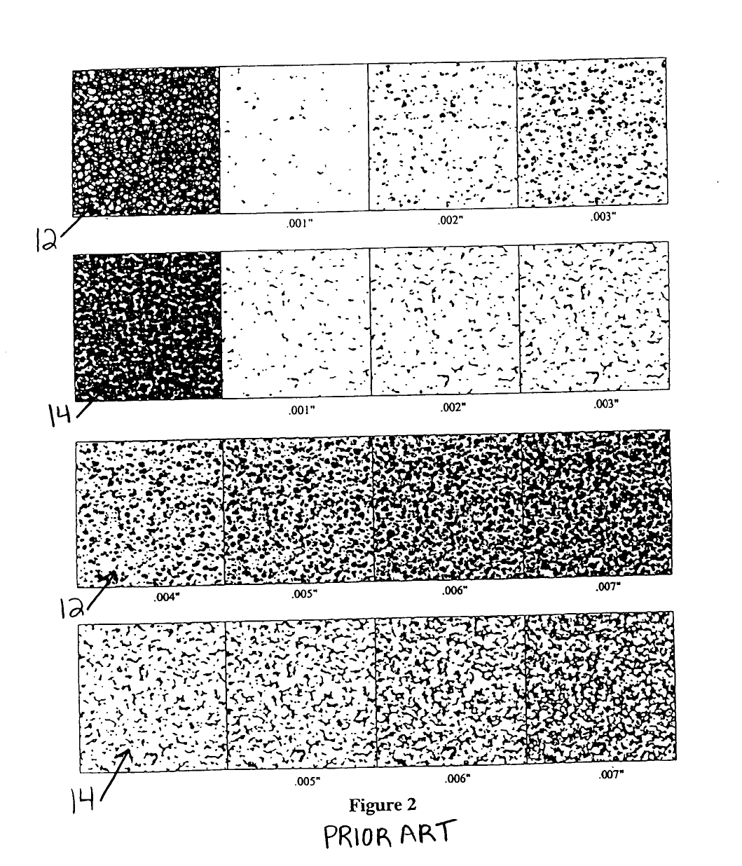

As shown in FIG. 2, the intersection of surface art at every level of pattern pickup-common is illustrated. As is easily seen, the land area of the top and bottom roller is substantially different when the top roller 12 is compared to the bottom roller 14 to every depth

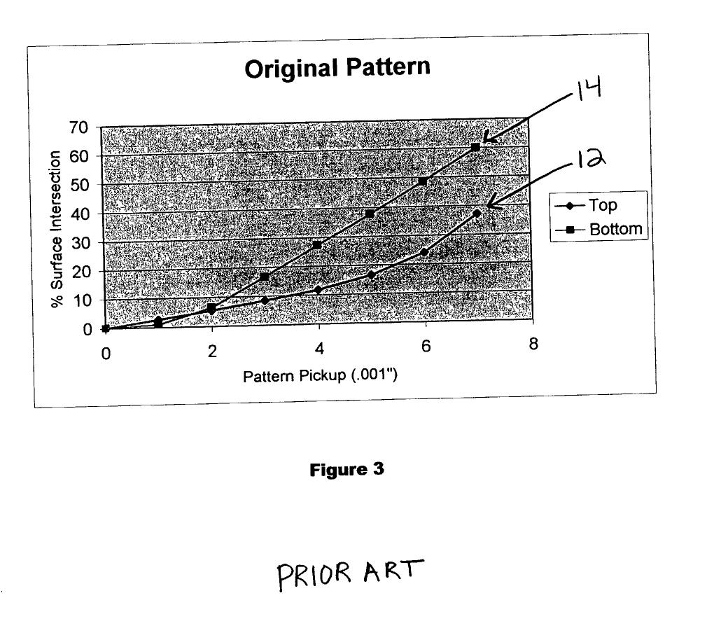

As shown in FIG. 3, a graph of prior art land area which is defined as % surface intersection versus pattern pickup comparing the top roller 12 to bottom roller 14 shows the induced strain for the top and bottom surfaces of the embossed sheet will be substantially different thus causing warpage.

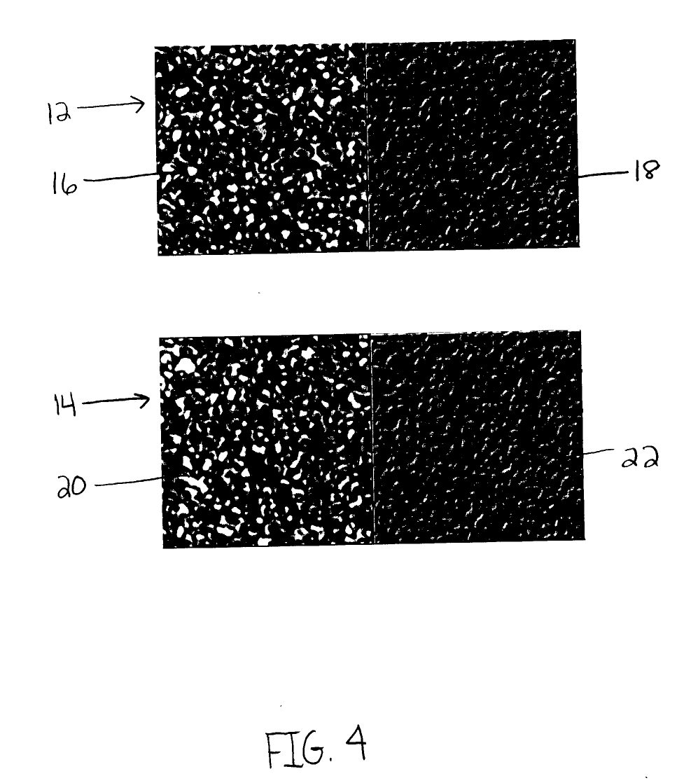

Now referring to FIG. 4, a surface that embodies the invention is depicted. As before, matched top roller 12 and bottom roller 14 is illustrated in both grayscale plots 16 and 20, respectively as well as shown in a rendered format 18 and 22, also respectively. These are typical surfaces of standard male/female embossing rollers as represented by grayscale plots where the level of grayness represents depth (0 to 255 corresponding linearly to 0 to 0.02 in.) and when rendered, where it is transformed to x. y, z and visually computer.

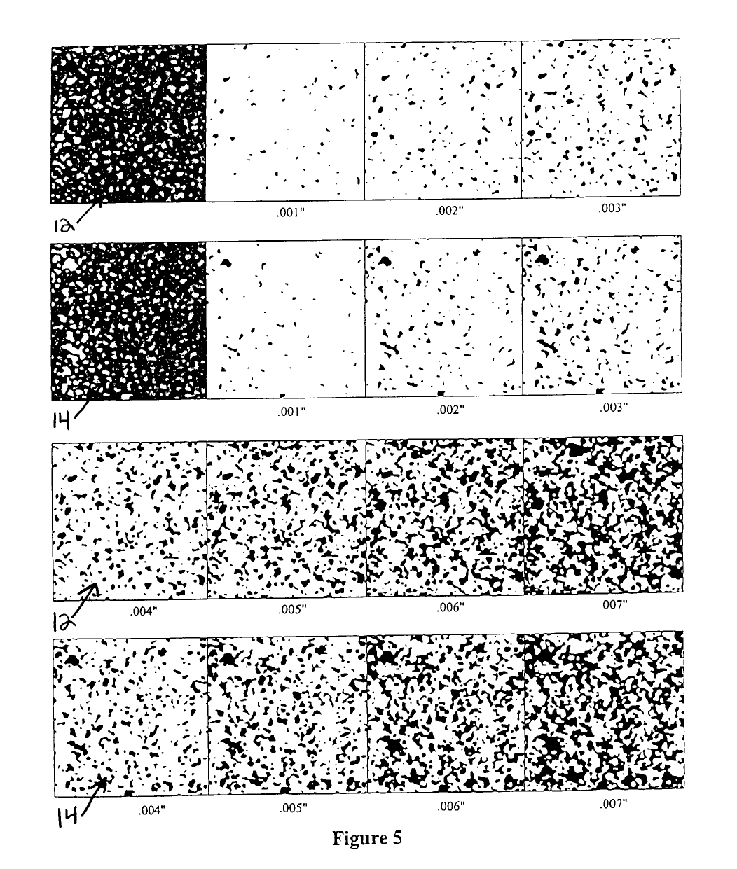

As shown in FIG. 5, again, the intersection of surface art at every level of pattern pickup-common is illustrated as in FIG. 2 for a prior art pattern. However, now, as is easily seen, the land area of the top and bottom roller is substantially the same when the top roller 12 is compared to the bottom roller 14 at every representative depth.

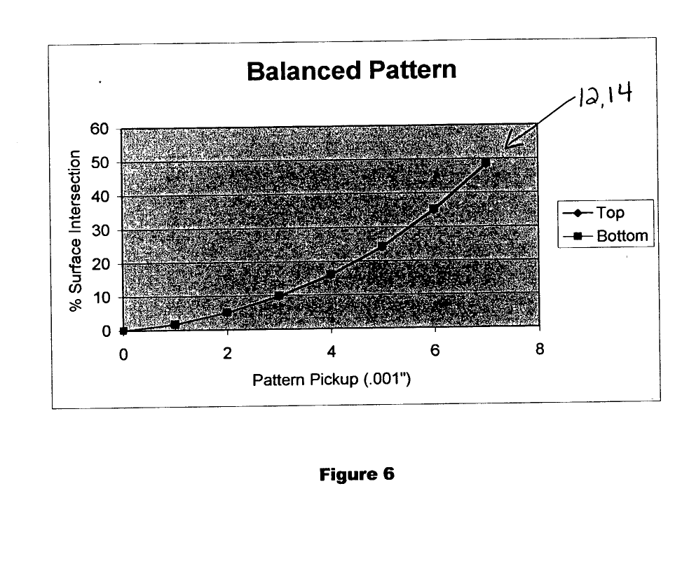

As shown in FIG. 6, a graph of land area which is defined as % surface intersection versus pattern pickup comparing the top roller 12 to bottom roller 14 shows the induced strain will be the same on each side of the sheet for this balanced pattern. Recalling the same plot for the prior art, FIG. 3, FIG. 6 shows that the graph for the top and bottom roller are the same, i.e., balanced. By balancing the pattern as described above, the balanced embossing substantially improves the quality of the embossed products and virtual eliminates warpage due to one side of the embossed sheet experiencing unbalanced strain as compared to the other side.

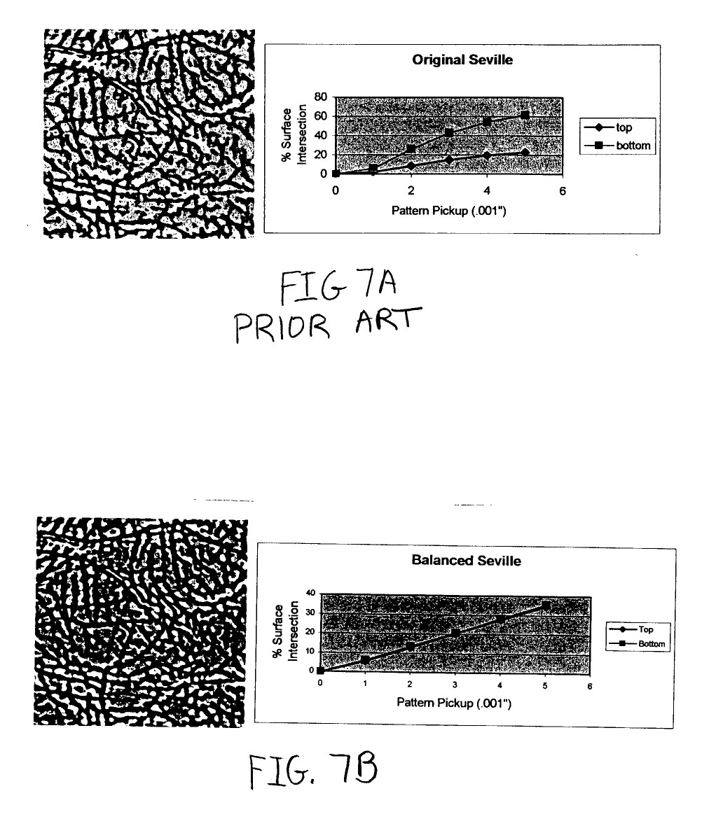

FIGS. 7A, 7B show how a balanced Seville pattern compares to the prior art Seville pattern. A Seville pattern is typically embossed on panels that used to make refrigerators.

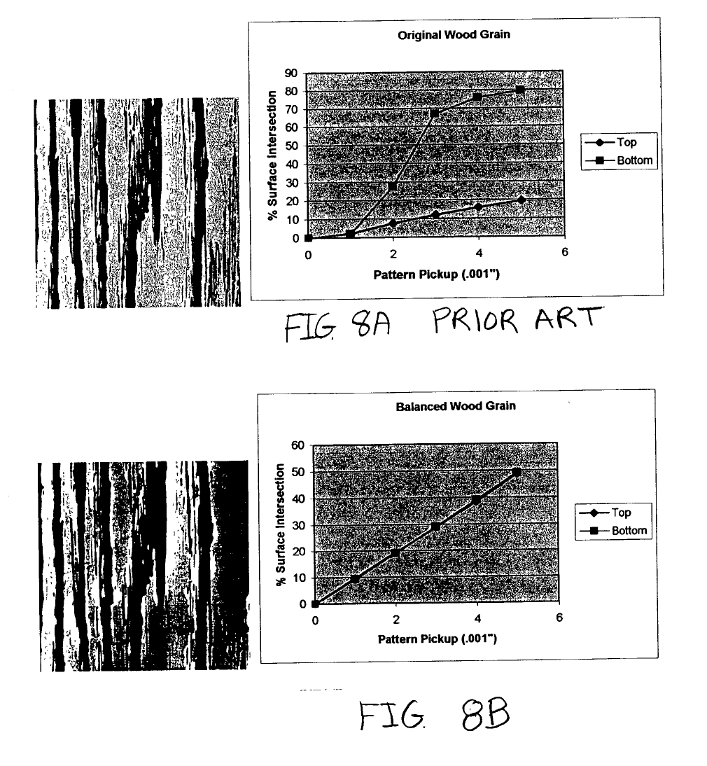

FIGS. 8A, 8B illustrate how a balanced wood grain pattern compares to the prior art wood grain pattern. This type of pattern is typically embossed on sheets used for building products. Again, the invention provides an embossed pattern where the top and bottom surfaces are now well controlled and the deformation of the material on each side of the sheet is the same. Sheets embossed in accordance with the invention do not require leveling and, in fact, the sheets are often flatter than unembossed, original sheet.

It is important to realize that for the pattern to be balanced that an accurate engraving must be realized such that all of the data is transferred particularly in the z dimension.

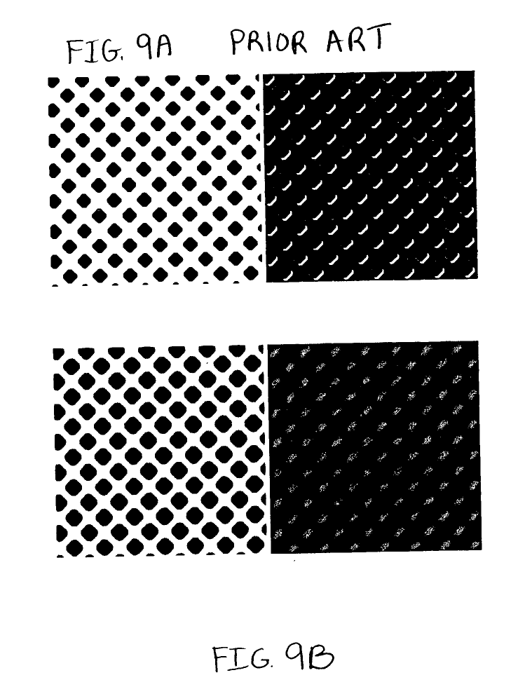

FIGS. 9A and 9B show a pattern that has been modified to insure that a controlled radius of curvature is placed on every figure element. This radius reduces the anvil effect during deformation and lowers forming forces by reducing cold work. It also makes a smoother pattern that induces less surface cracking. Controlling the figure radius of curvature has proven to improve corrosion resistance of embossed painted metal as evidenced by double to triple the salt spray resistance of the sheet. The prior art FIG. 9A shows embossing pins with straight walls while the invention FIG. 9B shows embossing pins have with a gradual radius of curvature which impacts the anvil effect when embossing. In this manner, forming pressures can be substantially reduced. The inventions have found that if the minimum radius of curvature is greater than 0.001 inches, the forming pressures can be reduced by at least 20% of what is typically used.

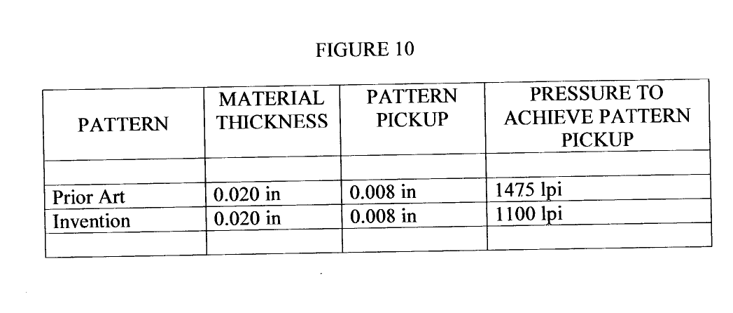

FIG. 10 is a table showing the typical pressures required to emboss 20 gauge metal sheets to a pattern pickup of 0.008 inches with the prior art as compared to the balanced embossing process.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. An embossing apparatus for use embossing a predetermined pattern onto substantially flat sheet material, said apparatus comprising:
a top roller having a top pattern having land areas corresponding to every level of pattern depth accurately engraved thereon,
a matching bottom roller having a bottom pattern having land areas corresponding to every level of patent depth accurately engraved thereon, wherein, each and every land area of said top pattern is substantially equal to each and every corresponding land area of said bottom level such that said sheet embossed with the predetermined pattern has equal strain on the bottom and top of said sheet independent of pattern pickup.

2. The embossing apparatus of claim 1 wherein the top and bottom roller patterns are calculated by digitally transforming the predetermined pattern in three dimensions such that there are representative features at every depth under the boundary conditions that the depth distribution is mirrored around the average depth.

3. The embossing apparatus of claim 1 wherein the top and bottom roller patterns are calculated by a digitally transforming that the predetermined pattern in three dimensions such that there are representative features at every depth under the boundary conditions the inverse of said predetermined pattern is taken and mathematically added back to the digitally transformed pattern at a slightly different angle.

4. The embossing apparatus of claim 1 wherein said rollers are engraved via a laser.

5. The embossing apparatus of claim 1 wherein said rollers are set-up for embossing on a sheet selected from the group consisting of a metal, plastic, synthetic wood and paper.

6. The embossing apparatus of claim 1 wherein the top and bottom roller patterns have been modified such that every figure has minimum radius of curvature to reduce forming stresses and improve the corrosion resistance of the embossed sheet.

7. The embossing apparatus of claim 6 wherein the minimum radius of curvature of every figure in said top and roller patterns is at least 0.001 inches such that forming pressures are reduced by at least 20%.

8. The method of embossing a substantially flat sheet material with a predetermined pattern comprising the steps of:
digitizing the predetermined pattern accurately in three dimensions,
transforming the digitized predetermined pattern such that there are representative features at every depth to provide a depth distribution thus providing an embossing pattern,
repeating the embossing pattern in both an x and y direction to avoid seeming in the embossed sheet material,
scaling the embossing pattern to nominally represent the feature size of the predetermined pattern to provide a male and female engraving pattern.
engraving the male engraving pattern onto one of a set of matched embossing tools and engraving the female engraving pattern onto the other one of the set of matched embossing tools,
embossing the predetermined pattern onto the sheet material such that strain on the top of the sheet material is substantially equal to the strain on the bottom of the sheet material.

9. The method of embossing of claim 8 wherein after said transforming step further comprising the step of mirroring the depth distribution around an average depth of the embossing pattern.

10. The method of embossing of claim 9 wherein after said transforming step further comprising the step of taking the inverse of the embossing pattern and mathematically adding back the inverse to the embossing pattern at a slightly different angle.
